(19) United States
(12) Patent Application Publication
(10) Pub. No.: US 2013/0202901 A1
(43) Pub. Date: Aug. 8, 2013

(54) PRINTABLE ELECTRONICS SUBSTRATE

(71) Applicant: David Max Roundhill, Seattle, WA (US)

(72) Inventor: David Max Roundhill, Seattle, WA (US)

(73) Assignee: EMPIRE TECHNOLOGY DEVELOPMENT LLC, Wilmington, DE (US)

(21) Appl. No.: 13/521,383

(22) PCT Filed: Feb. 3, 2012
(86) PCT No.: PCT/US12/23771

§ 371 Date: Jul. 10, 2012

(51) Int. Cl. B32B 27/06; B05D 3/02; B32B 27/28; B05C 9/14; B32B 27/36; B05D 5/12; B05D 3/04

(52) U.S. Cl. 428/473.5; 427/123; 118/58; 428/701; 428/480

(57) ABSTRACT

Technologies are generally described for a structure, and method and system effective to print a metallic conductor on a substrate. In some examples, the method may include providing a substrate. The method may further include attaching a first layer including at least one metal oxide to the substrate. The method may further include attaching a second layer including a first ink to the first layer, where the first ink includes a metal. The method may further include attaching a third layer including a second ink to the second layer. The method may further include sintering the third layer to form the metallic conductor.

### BACKGROUND

Unless otherwise indicated herein, the materials described in this section are not prior art to the claims in this application and are not admitted to be prior art by inclusion in this section.

Printing inks and pastes used in electronics applications may include particles dispersed in a fluid. The fluid may include a vehicle, dispersant, modifiers and/or a binder. The binder may be specific to a substrate upon which the printing ink will be deposited. The binder may also be chosen based on a sintering method used to convert the ink or paste into a metallic conductor.

### SUMMARY

In some examples, a method of printing a metallic conductor on a substrate is generally described. In some examples, the method may include providing a substrate. The method may further include attaching a first layer including at least one metal oxide to the substrate. The method may further include attaching a second layer including a first ink to the first layer. The first ink may include a metal. The method may further include attaching a third layer including a second ink to the second layer. The method may further include sintering the third layer to form the metallic conductor.

In some examples, a system effective to print a metallic conductor on a substrate is generally described. The system may include a first container effective to hold at least one metal oxide. The system may further include a second container effective to hold at least one metallic ink. The system may further include a chamber in operative relationship with the first container and the second container. The chamber may be effective to hold a substrate. The chamber may be further effective to receive the metal oxide and the metallic ink. The chamber may be further effective to attach a first layer to the substrate. The first layer may include the metal oxide. The chamber may be further effective to attach a second layer to the first layer. The second layer may include a first ink. The first ink may include a metal. The chamber may be further effective to attach a third layer to the second layer. The third layer may include a second ink. The chamber may be further effective to sinter the third layer to form the metallic conductor.

In some examples a structure is generally described. The structure may include a first layer attached to a substrate. The first layer may include a metal oxide. The structure may include a second layer attached to the first layer. The second layer may include a first ink. The first ink may include a metal. The structure may include a third layer sintered and attached to the second layer, wherein the third layer includes a second ink.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be used to form a printable electronics substrate;

FIG. 2 depicts a flow diagram for an example process for forming a printable electronics substrate;

FIG. 3 illustrates a computer program product that can be used to form a printable electronics substrate; and

FIG. 4 is a block diagram illustrating an example computing device that is arranged to form a printable electronics substrate;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to systems, methods, materials and apparatus related to a printable electronics substrate.

Briefly stated, technologies are generally described for a structure, and method and system effective to print a metallic conductor on a substrate. In some examples, the method may include providing a substrate. The method may further include attaching a first layer including at least one metal oxide to the substrate. The method may further include attaching a second layer including a first ink to the first layer, where the first ink includes a metal. The method may further include attaching a third layer including a second ink to the second layer. The method may further include sintering the third layer to form the metallic conductor.

It will also be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

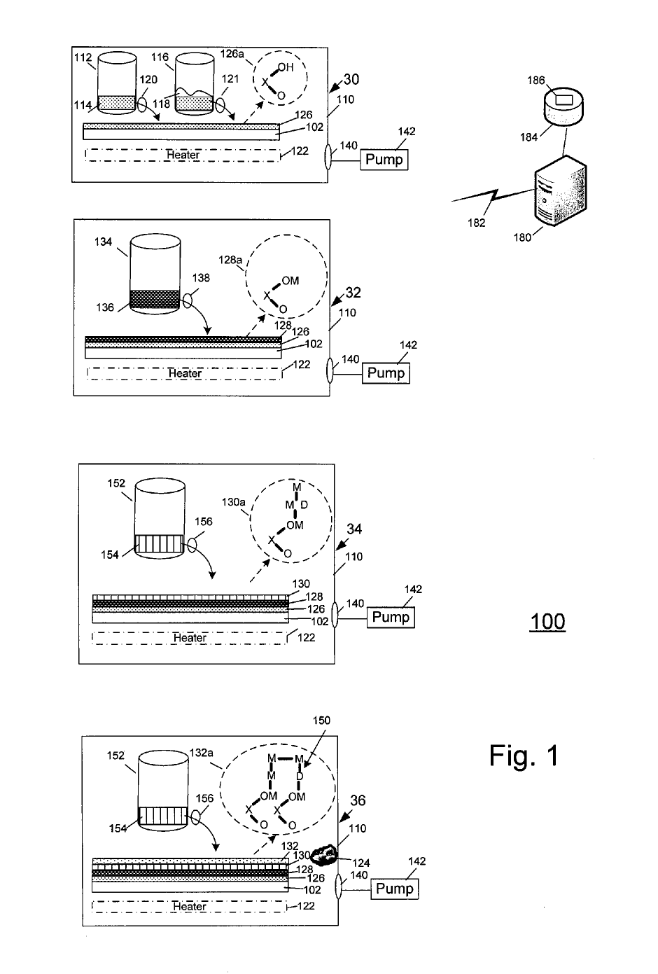

FIG. 1 illustrates an example system that can be used to form a printable electronics substrate in accordance with at least some embodiments described herein. An example printable electronics substrate formation system 100 may include one or more of a chamber 110, a container 112, container 116, container 134, container 152, a pump 142 and/or a heater 122. Heater 122 may be effective to control a temperature near heater 122 and may include a heating element and/or a cooling element. Chamber 110 may include a port 132 in communication with pump 142. At least some of these elements may be arranged in communication with a processor 180 through a communication link 182. In some examples, processor 180 may be adapted in communication with a memory 184 that may include instructions 186 stored therein. Processor 180 may be configured, such as by instructions 186, to control at least some of the operations/actions/functions described below.

In an example, as shown at 30, a metal oxide (shown as “X” in the figure) may be attached to the surface of a substrate 102 provided to chamber 110. Substrate 102 may be flexible substrate and may be made of an organic material such as polyester or polyimide. Substrate 102 may be made of glass, paper, cardboard, etc. In an example, substrate 102 may include flexible glass, a liquid crystal polymer (LCP), polyethylene, polypropylene, an elastomer, a rubber material, silicones such as polydimethylsiloxane, thermal release tapes, adhesive tape, graphene film, graphene oxide film, polyamides such as nylon types, fabrics and cloth such as cotton and rayon, polycarbonates, polyolefins such as polyethylene and polypropylene, polyacetylenes, a boron nitride polymer, etched polyfluoroolefins such as polytetrafluoroethylene (PTFE), etc.

Substrate 102 may be heated, such as by heater 122, to a temperature of at least about 25 degrees Celsius to soften the substrate. In an example, metal oxide powder may be attached to substrate 102 from container 112 through port 120. In an example, metal oxide may be attached to substrate 102 in the form of an aqueous slurry 118 from container 116 through port 121. Metal oxide 114, 118 may include at least one metal oxide and may be, for example, TiO₂, Al₂O₃, SiO₂, MgO, CaO, BaO, Ce₂O₃, M₂O₃ (where M is a lanthanide ion), ZrO₂, etc. Metal oxide 114, 118 may be a non-reducible metal oxide. Pump 142 and port 140 may be adapted to control an atmosphere of chamber 110 to be at about atmospheric pressure to about 10⁻¹ Pa or 10⁻³ mbar. Attaching metal oxide 114, 118 to substrate 102 may form layer 126 with the chemical structure 126a.

In an example, as shown at 32, a layer of metallic ink 136 may be attached to metal oxide 114, 118 such as through a condensation or dehydration reaction to form layer 128 with the chemical structure 128a. Metal particles in metallic ink 136 may include metal nanoparticles and may have a native oxide or hydroxide layer on their surface. In some examples, a nanoparticle may be a particle of any shape, including but not limited to, spheroid, oblong, polygonal, and globular structure and have at least two physical dimensions of about 1 nm to about 100 nm. Metallic ink 136 may include, for example, a metallic paste and may be applied to substrate 102 from container 134 through port 138. Pump 134 and port 132 may control an atmosphere of chamber 110 to be at about from atmospheric pressure down to 10⁴ Pa or 10⁻³ mbar. Metal oxide 114, 118 may react with the native oxide or hydroxide layer on the surface of metallic ink 136 through thermal dehydration. In an example where metal oxide 114, 118 includes titanium oxide and metallic ink 136 includes silver oxide, the reaction may be expressed as Ti—OH+HO—Ag−>Ti—O—Ag+H₂O.

In an example, metallic ink 136 may include an ink such as a stabilizer with up to about a 5% weight percentage, a co-solvent of about 1% to about 10% weight percentage, and a solvent. For example, an ink formulation may include silver nanoparticles (of about 35% to about 60% by weight), dodecane solvent, oleic acid stabilizer as a dispersant, and dodecanol, geraniol and terpineol as co-solvents. In an example, an ink formulation may include silver nanoparticles (of about 40% by weight), a decane solvent, a nonylamine stabilizer as a dispersant, and a terpineol co-solvent.

In an example, metallic ink 137 may include a paste such as a stabilizer of up to about a 5% weight percentage, a co-solvent of about 1% to about 10% weight percentage, and a solvent. In an example, a paste formulation may include silver nanoparticles (of about 60% to about 70% by weight), a hexadecane solvent, oleic acid stabilizer as a dispersant, and hexadecanol, geraniol and terpineol as co-solvents. In another example, a paste formulation may include silver nanoparticles (of about 60% to about 70% by weight), a hexadecane solvent, a hexadecylamine stabilizer as a dispersant, and a terpineol co-solvent.

In an example, as shown at 34, printing may be performed on substrate 102 by depositing one or more layers of ink on layer 128 to form one or more layers 130 with the chemical structure 130a. Layer 130 may be applied to layer 128 from container 152 through port 156. Layers 130 may include a metal as shown with the letter “M” or a dielectric as shown by the letter “D”. Layers 130 may be made of the same ink or a different ink than ink in layer 128. Printing may include, for example, ink jet printing, aerosol jet printing, stamping, gravure printing, flexographic printing, offset printing, screen printing, etc.

As shown at 36, a top layer of ink 136 may include a metal and may be sintered to reduce and fuse oxides in printed ink 136. For example, heater 122 may heat substrate 102 to a temperature of at least about 25 degrees Celsius and gas 124 may be applied to substrate 102 to fuse ink 136 and form layer 132 with chemical structure 132a. As shown, chemical structure 132a includes metal particles fused together to form a metallic conductor 150. Gas 124 may include a mixture of about 5% to about 10% hydrogen in nitrogen and may be applied by pump 142 through valve 140. Metallic conductor 150 may be bound to substrate 102. Metal oxide 114, 118 may be chosen so as to avoid the reduction reaction shown at 36. In this way metal oxide layer 104 remains attached to substrate 102.

Among other benefits, a system arranged in accordance with the present disclosure may be used to form a printable electronics substrate. Metallic ink may be bonded to a flexible substrate that may not be compatible with a printed electronic ink, such as may be the case with an organic substrate. Such substrates may be used in flexible printed electronics like printed circuit boards, batteries, roll up screens, electronic newsprint, etc. A binder need not be added to the metallic ink.

In an example, a metallic conductor may be printed on a substrate. A substrate, such as a polyimide may be provided. A first layer may be attached to the substrate. The first layer may include a metal oxide such as aluminum oxide and may be attached by spreading the aluminum oxide as an aqueous slurry onto a softened surface of the polyimide. A second layer including a first ink may be attached to the first layer such as by an inkjet process. The first ink may include a metal such as a water based silver nanoparticle ink. A third layer including a second ink may be attached to the second layer such as by a gravure printing process. The third layer may be sintered to form the metallic conductor.

In an example, a system may be effective to print a metallic conductor on a substrate. The system may include a first container effective to hold at least one metal oxide such as aluminum oxide. The system may include a second container effective to hold at least one metallic ink such as a solvent based copper nanoparticle ink. A chamber such as an inert atmosphere or vacuum chamber may be in operative relationship with the first container and the second container. The chamber may be effective to hold a substrate and receive the metal oxide and the metallic ink. The chamber may be further effective to attach a first layer to the substrate. The substrate may be, for example a liquid crystal polymer. The first layer may be attached to the substrate by, for example, a screen printing process. The first layer may include the metal oxide. The chamber may be effective to attach a second layer to the first layer such as by an offset printing process. The second layer may include a first ink and the first ink may include a metal such as a nickel paste. The chamber may be effective to attach a third layer to the second layer such as by a stamp printing process. The third layer may include a second ink. The chamber may be effective to sinter the third layer to form the metallic conductor.

In an example, a structure may include a first layer attached to a substrate. The first metal oxide layer may be attached to the substrate in a variety of methods depending on the individual substrate. In examples including porous or hydrophilic and oxophilic substrates such as paper, glass, cloth, etched TEFLON, flexible glass, silicon, graphene oxide, etc, this layer can be transferred directly onto a surface of the substrate. This transfer can be achieved by coating an aqueous slurry of the metal oxide onto the substrate and carrying out dehydration using a vacuum (such as about 10⁻¹ Pa or 10⁻³ mbar), applying heat, light or a laser flash. In another example, the metal oxide layer can be printed in a pattern that will be subsequently used for printing the metallic conductor. After this pattern has been dehydrated and bound to the porous hydrophilic substrate, the metallic inks or paste may then be printed onto this dried metal oxide pattern. For non-porous hydrophobic substrates such as polyimides, polyesters, polyolefins, polyacetylenes, nylon, graphene, etc, and alternative strategy may be used. One method is to thermally treat the surface of the polymer until the surface of the polymer softens, and then add the first layer metal oxide as a solid or a slurry. Again this can be done on the entire sheet of the polymer or the metal oxide can be printed in a patterning process in the same manner as the procedure for the porous hydrophilic substrates.

The substrate may be a polyester. The first layer may include a metal oxide such as titanium dioxide. A second layer may be attached to the first layer such as by a flexographic printing process. The second layer may include a first ink or paste such as a gold nanoparticle formulation. The first ink or paste may include a metal such as gold. A third layer may be sintered and attached to the second layer such as by aerosol jet printing. The third layer may include a second ink such as an aluminum ink.

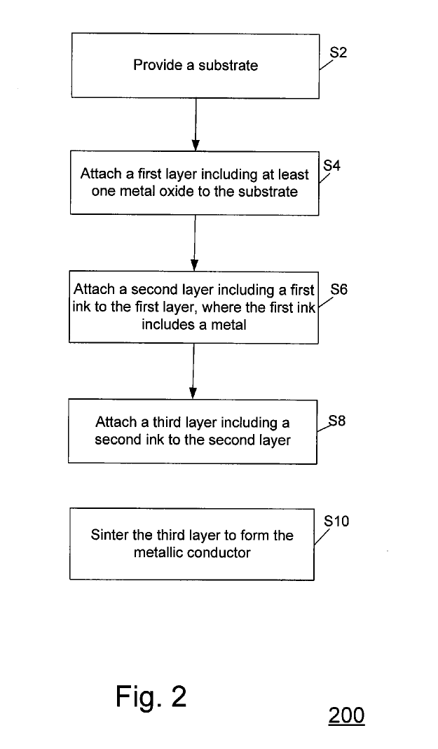

FIG. 2 depicts a flow diagram for an example process 200 for forming a printable electronics substrate in accordance with at least some embodiments described herein. The process in FIG. 2 could be implemented using, for example, system 100 discussed above. An example process may include one or more operations, actions, or functions as illustrated by one or more of blocks S2, S4, S6, S8 and/or S10. Although illustrated as discrete blocks, various blocks may be divided into additional blocks, combined into fewer blocks, or eliminated, depending on the desired implementation.

Process 200 may begin at block S2, “Provide a substrate.” At block S2, a substrate, such as a flexible substrate made out of glass, an organic material, paper, etc. may be provided. Processing may continue from block S2 to block S4, “Attach a first layer including at least one metal oxide to the substrate.” At block S4, a first layer including a metal oxide may be attached to the substrate. The metal oxide may be, for example, a metal oxide powder or an aqueous slurry. In some examples, the metal oxide may include at least one of TiO₂, Al₂O₃, SiO₂, or combinations thereof

Processing may continue from block S4 to block S6, “Attach a second layer including a first ink to the first layer, where the first ink includes a metal.” At block S6, a second layer including a first ink may be attached to the first layer. In some examples, attaching the second layer includes performing a condensation reaction or a dehydration reaction. The first ink may include metal.

Processing may continue from block S6 to block S8, “Attach a third layer including a second ink to the second layer.” At block S8, a third layer may be attached to the second layer including a second ink. The second ink may be the same as the first ink or different from the first ink. The second ink may include a dielectric. Processing may continue from block S8, to block S10, “Sinter the third layer to form the metallic conductor.” At block S10, the third layer may be sintered to form a metallic conductor. In examples where the second ink is a dielectric, a fourth layer including a metal may be attached on top of the layer including a dielectric and the fourth layer may be sintered to form the metallic conductor.

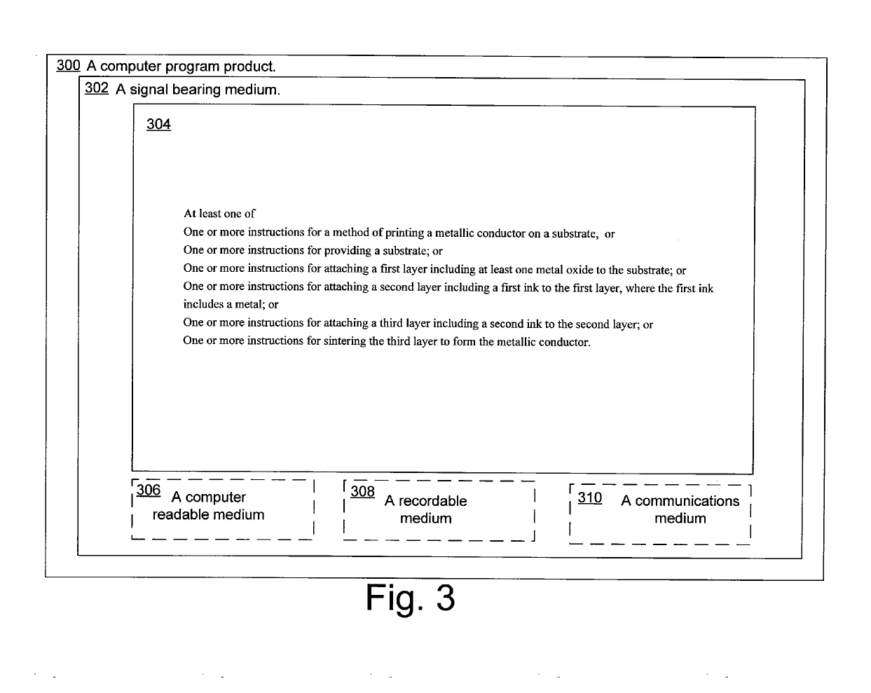

FIG. 3 illustrates a computer program product that can be used to form a printable electronics substrate in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-2. Thus, for example, referring to system 100, processor 180 may undertake one or more of the blocks shown in FIG. 3 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

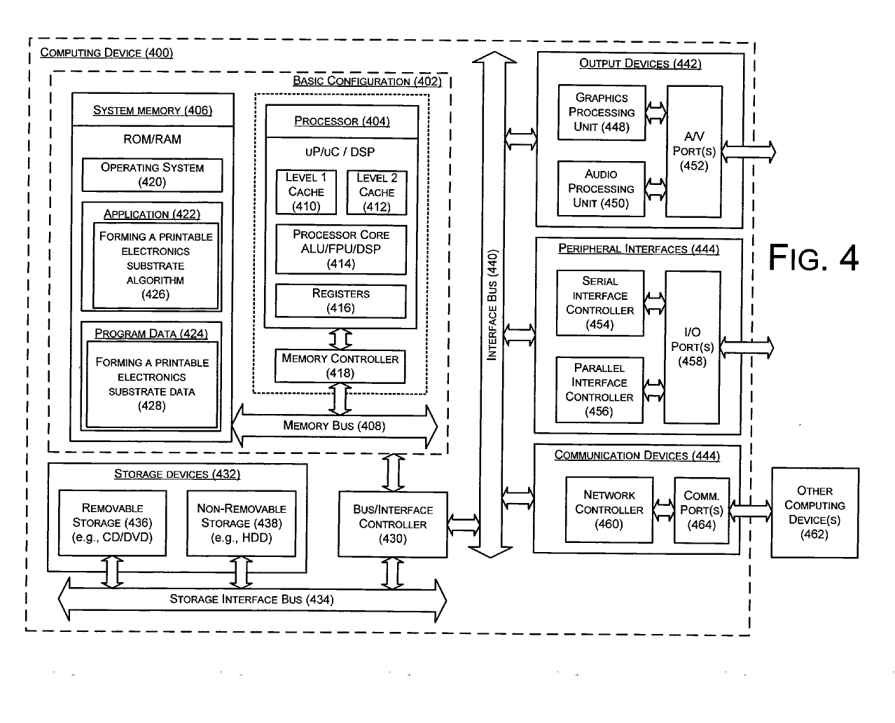

FIG. 4 is a block diagram illustrating an example computing device that is arranged to form a printable electronics substrate according to at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a forming a printable electronics substrate algorithm 426 that is arranged to perform the various functions/actions/operations as described herein including at least those described with respect to system 100 of FIGS. 1-3. Program data 424 may include a forming a printable electronics substrate data 428 that may be useful for forming a printable electronics substrate as is described herein. In some embodiments, application 422 may be arranged to operate with program data 424 on operating system 420 such that formation of a printable electronics substrate may be provided. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such , computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of printing a metallic conductor on a substrate, the method comprising:
providing a substrate;
attaching a first layer including at least one metal oxide to the substrate;
attaching a second layer including a first ink to the first layer, where the first ink includes a metal, a stabilizer, a solvent and a co-solvent;
printing a third layer including a second ink on the second layer; and
sintering the third layer to form the metallic conductor.

2. The method of claim 1, wherein the first and second ink include different metals.

3. The method of claim 1, wherein the first and the second ink are the same ink.

4. The method of claim 1, further comprising:
attaching a fourth layer including a dielectric on the second layer; and
wherein printing the third layer on the second layer includes attaching the third layer to the fourth layer.

5. The method of claim 1, wherein the substrate includes an organic material.

6. The method of claim 1, wherein the substrate is made of at least one of polyester or polyimide.

7. The method of claim 1, wherein attaching the first layer to the substrate includes heating the substrate to a temperature of at least 25 degrees Celsius.

8. The method of claim 1, wherein attaching the first layer to the substrate includes attaching metal oxide powder to the substrate.

9. The method of claim 1, wherein attaching the first layer to the substrate includes attaching an aqueous slurry of metal oxide to the substrate.

10. The method of claim 1, wherein the metal oxide includes at least one of TiO₂, Al₂O₃, SiO₂, MgO, CaO, BaO, Ce₂O₃, M₂O₃, ZrO₂, where M is a lanthanide ion, or combinations thereof.

11. (canceled)

12. The method of claim 1, wherein attaching the second layer includes performing a condensation reaction or a dehydration reaction.

13. The method of claim 1, wherein sintering includes:
heating the substrate to a temperature of at least about 25 degrees Celsius; and
applying a gas to the substrate.

14. The method of claim 1, wherein sintering includes:
heating the substrate to a temperature of at least about 25 degrees Celsius; and
applying a gas to the substrate, wherein the gas includes H₂ and N₂.

15. The method of claim 1, wherein:
the substrate is made of at least one of polyester or polyimide;
attaching the first layer to the substrate includes heating the substrate to a temperature of at least about 25 degrees Celsius;
the metal oxide includes at least one of TiO₂, Al₂O₃, SiO₂, MgO, CaO, BaO, Ce₂O₃, M₂O₃, ZrO₂, where M is a lanthanide ion, or combinations thereof;
attaching the second layer includes performing a condensation reaction or a dehydration reaction; and
sintering includes heating the substrate to a temperature of at least about 25 degrees Celsius and applying a gas to the substrate, wherein the gas includes H₂ and N₂.

16. (canceled)

17. (canceled)

18. (canceled)

19. (canceled)

20. (canceled)

21. The method of claim 1, wherein the first ink includes nanoparticles of the metal.

22. A system effective to print a metallic conductor on a substrate, the system comprising:
a first container effective to hold at least one metal oxide;
a second container effective to hold at least one metallic ink; and
a chamber in operative relationship with the first container and the second container, the chamber effective to
hold a substrate, p2 receive the metal oxide and the metallic ink;
attach a first layer to the substrate, wherein the first layer includes the metal oxide;
attach a second layer to the first layer, wherein the second layer includes a first ink and the first ink includes a metal, a stabilizer, a solvent and a co-solvent;
print a third layer on the second layer, wherein the third layer includes a second ink; and
sinter the third layer to form the metallic conductor.

23. (canceled)

24. (canceled)

25. (canceled)

26. (canceled)

27. (canceled)

28. (canceled)

29. The system of claim 22, wherein the metal oxide remains attached to the substrate after the sinter.

30. (canceled)

31. (canceled)

32. (canceled)

33. (canceled)

34. The system of claim 22, wherein the first and second ink include different metals.

35. The system of claim 22, wherein the first and the second ink are the same ink.

36. The system of claim 22, further comprising:
a third container in operative relationship with the chamber, wherein the third container includes a dielectric; and
the chamber is further effective to attach a fourth layer to the second layer, wherein the fourth layer includes the dielectric; and wherein
the third layer is attached to the fourth layer.

37. The system of claim 22, wherein the first ink includes nanoparticles of the metal.

38. A structure comprising:
a first layer attached to a substrate, wherein the first layer includes a metal oxide;
a second layer attached to the first layer, wherein the second layer includes a first ink and the first ink includes a metal, a stabilizer, a solvent, and a co-solvent; and
a third layer sintered and printed on the second layer, wherein the third layer includes a second ink.

39. (canceled)

40. The structure of claim 38, wherein the substrate is made of at least one of polyester or polyimide.

41. The structure of claim 38, wherein the metal oxide includes at least one of TiO₂, Al₂O₃, SiO₂, MgO, CaO, BaO, Ce₂O₃, M₂O₃, ZrO₂, where M is a lanthanide ion, or combinations thereof.

42. (canceled)

43. (canceled)

44. (canceled)

45. (canceled)

46. The structure of claim 38, wherein:
the first layer consists of the metal oxide;
the second layer consists of the metallic ink;
the substrate consists of polyester or polyimide; and
the third layer consists of the metallic ink.

47. (canceled)

48. (canceled)

49. (canceled)
